(19) United States
(12) Patent Application Publication
(10) Pub. No.: US 2021/0157553 A1
(43) Pub. Date: May 27, 2021

(54) SOURCE CODE AUTO-SUGGESTION BASED ON STRUCTURAL AND SEMANTIC FEATURES

(71) Applicant: International Business Machines Corporation, Armonk, NY (US)

(72) Inventors: Joseph LIGMAN, Wilton, CT (US); David M. LUBENSKY, Brookfield, CT (US); Marco PISTOIA, Amawalk, NY (US); Justin David WEISZ, Scarsdale, NY (US)

(21) Appl. No.: 16/690,600

(22) Filed: Nov. 21, 2019

(51) Int. Cl. G06F 8/35; G06F 8/73; G06F 8/74; G06K 9/62; G06N 20/00

(52) U.S. Cl. CPC G06F 8/35; G06F 8/73; G06N 20/00; G06K 9/6217; G06K 9/6215; G06F 8/74

(57) ABSTRACT

A method, system and apparatus for source code auto-suggestion, including receiving and processing source code from a source code repository, extracting one or more features from the source code received from the source code repository, extracting one or more features from the source code within a development environment, comparing the one or more features from the source code received from the source code repository with the one or more features extracted from the source code within the development environment, and providing a segment of source code from the received and processed source code repository according to a similarity to the source code within the development environment.

### BACKGROUND OF THE INVENTION

### Field Of The Invention

The disclosed invention relates generally to an embodiment of a method, apparatus, and system for a source code auto-suggestion, and more particularly, but not by way of limitation, relates to a method, apparatus, and system for source code auto-suggestion based on structural and semantic features.

### Description of The Background Art

When writing source code, programmers often use similar patterns of source code over and over in different places within a computer program or a series of computer programs. These patterns of source code may be structural in nature, such as using nested for loops to iterate over a data structure with multiple dimensions. The structural feature can refer to issues such as the actual syntactic structure of the program along with the control and data flow that it represents.

Syntax is another feature of source code that can be looked at. The syntax of a computer language is the set of rules that defines the combinations of symbols that are considered to be a correctly structured document or fragment in that language.

One may find pre-existing source code to perform certain tasks for insertion within a computer program, but there is currently no efficient way to automatically generate customized source code. The mass complexity in today's programming needs a manner to more efficiently develop the complex software programs.

Advancements in computer science as of late has led to a rise of machine learning or artificial intelligence, which is used to broadly describe a primary function of electronic systems that learn from data and generate results in somewhat similar fashion to a human being. There is a need for advanced software techniques to develop software, where machine learning or artificial intelligence can be utilized.

Therefore, it is desirable to provide an improved technique for automatically developing software programs that can be more accurate, easier to implement, and increase efficiency.

### SUMMARY OF INVENTION

In view of the foregoing and other problems, disadvantages, and drawbacks of the aforementioned background art, an exemplary aspect of the disclosed invention provides a method, apparatus, and system for learning model agnostic multilevel explanations.

One aspect of the present invention is to provide a method for source code auto-suggestion, the method including receiving and processing source code from a source code repository, extracting one or more features from the source code received from the source code repository, extracting one or more features from the source code within a development environment, comparing the one or more features from the source code received from the source code repository with the one or more features extracted from the source code within the development environment, and providing a segment of source code from the received and processed source code repository according to a similarity to the source code within the development environment.

Another aspect of the present invention provides system for source code auto-suggestion, including a computer, including a memory storing computer instructions, and a processor configured to execute the computer instructions to receive and processing source code from a source code repository, extract one or more features from the source code received from the source code repository, extract one or more features from the source code within a development environment, compare the one or more features from the source code received from the source code repository with the one or more features extracted from the source code within the development environment, and provide a segment of source code from the received and processed source code repository according to a similarity to the source code within the development environment.

Another example aspect of the disclosed invention is to provide computer program product comprising a computer readable storage medium having program instructions embodied therewith, the program instructions readable and executable by a computer to cause the computer to perform a method, including receiving and processing source code from a source code repository, extracting one or more features from the source code received from the source code repository, extracting one or more features from the source code within a development environment, comparing the one or more features from the source code received from the source code repository with the one or more features extracted from the source code within the development environment, and providing a segment of source code from the received and processed source code repository according to a similarity to the source code within the development environment.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF DRAWINGS

The exemplary aspects of the invention will be better understood from the following detailed description of the exemplary embodiments of the invention with reference to the drawings.

FIG. 1 illustrates a system of an example embodiment of the present invention.

FIG. 2 illustrates a cloud implementation of the system in an example embodiment of the present invention.

FIG. 3 illustrates further detail of program or client app in example embodiment for code auto-suggestion based on structural and semantic features.

FIG. 4 illustrates a method of an example embodiment for code auto-suggestion based on structural and semantic features.

FIG. 5 illustrates further detail for system in an example embodiment of the present invention.

FIG. 6 illustrates a method for the system in an example embodiment of the present invention.

FIG. 7 illustrates a method of an example embodiment for code auto-suggestion based on structural and semantic features.

FIG. 8 illustrates a system of an example embodiment for code auto-suggestion based on structural and semantic features.

FIG. 9 illustrates an example implementation for code auto-suggestion based on structural and semantic features.

FIG. 10 illustrates an exemplary hardware/information handling system for incorporating the example embodiment of the present invention therein.

FIG. 11 illustrates a signal-bearing storage medium for storing machine-readable instructions of a program that implements the method according to the example embodiment of the present invention.

FIG. 12 depicts a cloud computing node according to an example embodiment of the present invention.

FIG. 13 depicts a cloud computing environment according to an example embodiment of the present invention.

FIG. 14 depicts abstraction model layers according to an example embodiment of the present invention.

### DETAILED DESCRIPTION OF PREFERRED EMBODIMENTS

The invention will now be described with reference to the drawing figures, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims. Moreover, please note that any of the steps can be performed in different sequences or combined or at the same time. In addition, any of structures shown can be modified or combined.

The present system provides auto-completed code block suggestions based on code and comments being written in a code editor, such as an interactive development environment or other type of source code editor. Code block suggestions are drawn from a large repository of previously written source code. Machine learning and similarity-matching algorithms are used to determine which code blocks are used to perform an auto-completion.

There are solutions using suggestions that are provided based on compiler technology. For example, if the developer is entering some characters and it turns out that the characters entered match the beginning of a variable or function name already declared in the program and visible at that point of the program, then the system may provide the full variable or function name as a suggestion for autocompletion. More sophisticated solutions will only provide suggestions that are not going to cause compilation errors. However, the present system significantly extends beyond compiler-based technology because it does not just provide the suggestion for autocompleting a simple word in the program, but an entire code fragment implementing a given functionality. The autocomplete of source code of the present invention involves providing complete code fragments and not merely individual tokens.

Autocomplete of source code is also known as code completion. In a source code editor (such as an interactive development environment) autocomplete is greatly simplified by the structure of the programming languages. For example, there are usually only a limited number of words or code blocks or code fragments that are meaningful in the current context or namespace, such as names of variables and functions. The source code editor can be, for example, a standalone program or built into an integrated development environment.

For example, code completion may involve, in an embodiment of the invention, automatically displaying a pop-up list of possible completions for the current input (such as a prefix or beginning portion of the input) to allow the user to choose the right one. This is particularly useful in object-oriented programming because often the programmer will not know exactly what members a particular class has. Therefore, autocomplete then serves as a form of convenient documentation as well as an input method.

Another beneficial feature of autocomplete for source code is that it encourages the programmers to use longer, more descriptive variable names incorporating both lower- and upper-case letters (CamelCase, alternatively referred to as bicapitalisation, medial capitals, and Pascal case), which make the source code more readable but are long and cumbersome to type. For example, in computer programming CamelCase (where internal capital letters can resemble the humps on a camel's back) is often used as a naming convention for naming variables, arrays, and other elements such as “$MyVariable”. Typing large words with many mixed cases like “numberOfWordsPerParagraph” can be difficult and prone to error. Autocomplete allows one to complete typing the word using a fraction of the keystrokes.

As mentioned, when writing source code, programmers often use similar patterns over and over in different places within the source code. These patterns may be structural in nature, such as using nested for loops to iterate over a data structure with multiple dimensions. They may also be semantic in nature, such as writing similar-looking code to perform the same “higher-level” task, such as setting the label and background color of a UI (User Interface) element. The semantics of source code is another feature that can be analyzed. Semantic features can refer to the meaning or logic of the source code.

In both cases, two pieces of code may perform the “same” functionality, but on the surface the code looks different because of differing variable names. The disclosed invention seeks to aid developers at identifying when they are writing code that has “already” been written before, “already” in the sense that similar code to what they are writing already exists in a source repository.

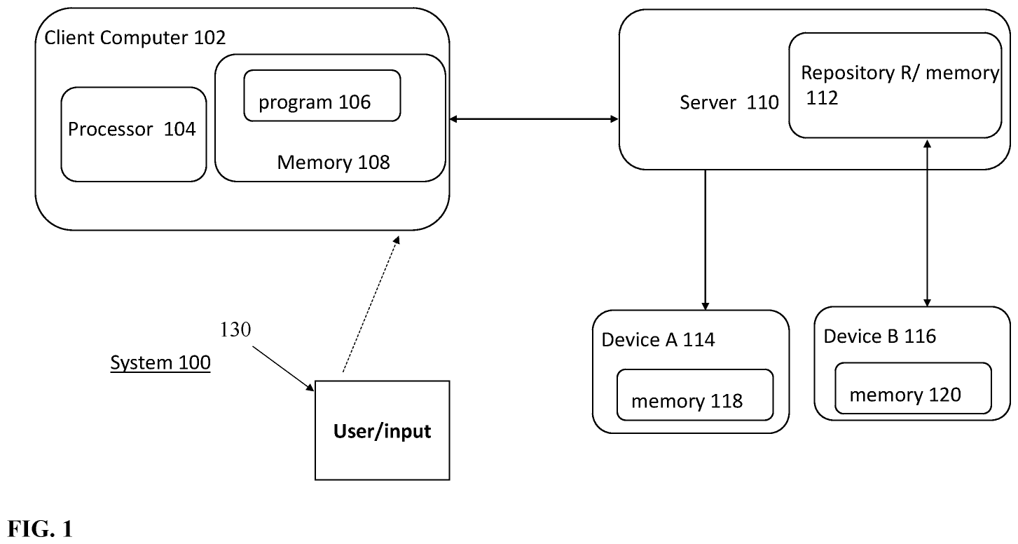

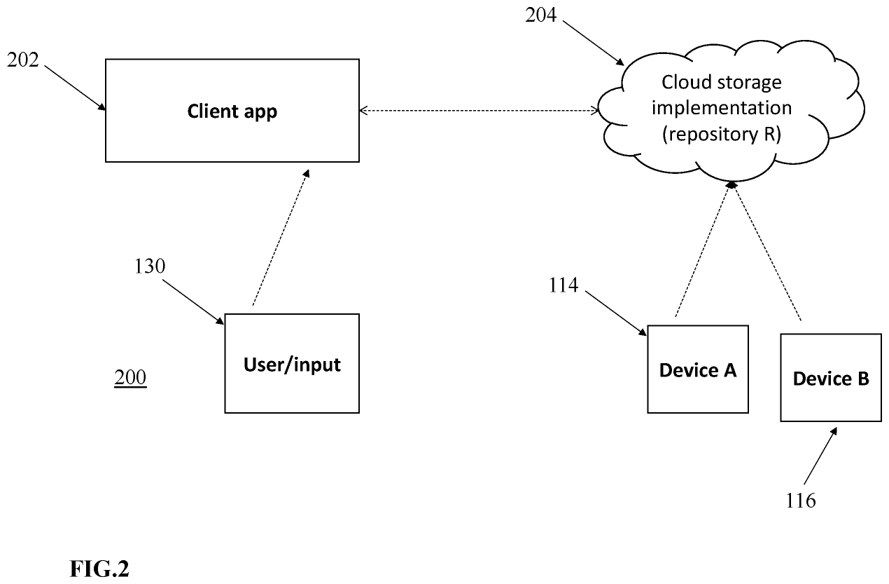

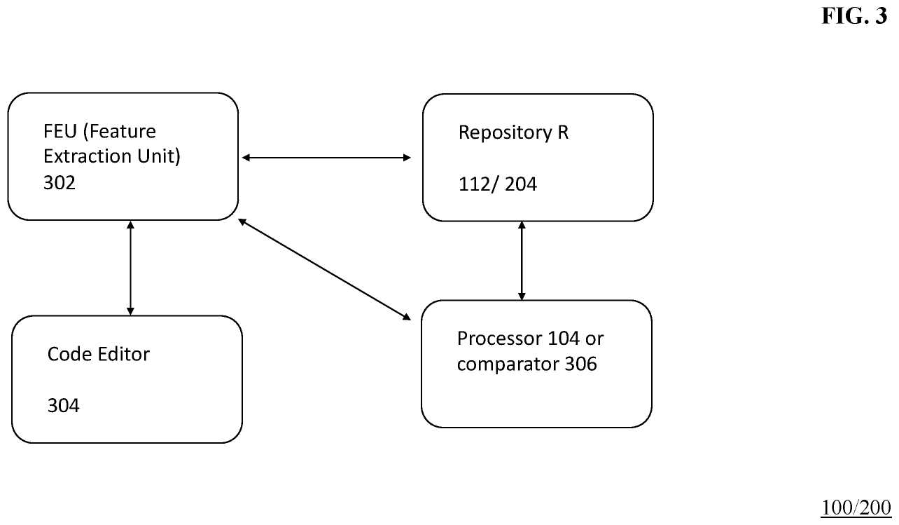

Two example systems are shown in FIGS. 1 and 2, which will be described in more detail later in the disclosure. FIG. 1 illustrates a system 100 in an example embodiment of the present invention. FIG. 2 illustrates a cloud implementation of the system 200 in an example embodiment of the present invention. FIG. 3 illustrates further detail of program 106 or client app 202 in an example embodiment for code auto-suggestion based on structural and semantic features. Please note that any of the structural units, hardware, or software modules shown can be modified or combined.

In order to identify this similar code, the present system 100, 200 performs a number of steps to extract code from a repository of previously written source code, parse it to identify meaningful blocks at different lexical scopes, and extract features for each block that describes its structural and semantic nature.

Then, when a programmer 130 invokes an auto-complete command, the system 100, 200 uses the same feature extraction method on the in-progress code being written, in order to compare its structural and/or semantic similarity to the code blocks in the repository 112, 204 at the same lexical scope. The similarity function returns a metric of how similar the in-progress code is to the code block in the repository 112, 204, and auto-complete suggestions are made on the basis of code that has the highest similarity.

The auto-complete suggestions can be any form and is not limited to any particular user interface. For example, the auto-complete suggestion can be pop-up window, search box, or highlighted text where the user is typing in the editor. The auto-complete suggestions can even be in a command line pop-up window or highlighted text using a command line interpreter for command line type editors. Other alternative methods of auto-complete suggestions can be used. However, as mentioned, the autocomplete of source code of the present invention involves providing complete code fragments and not merely individual tokens. For example, a complete code fragment including an entire loop or function(s) can be autocompleted rather than merely a completion of a simple word.

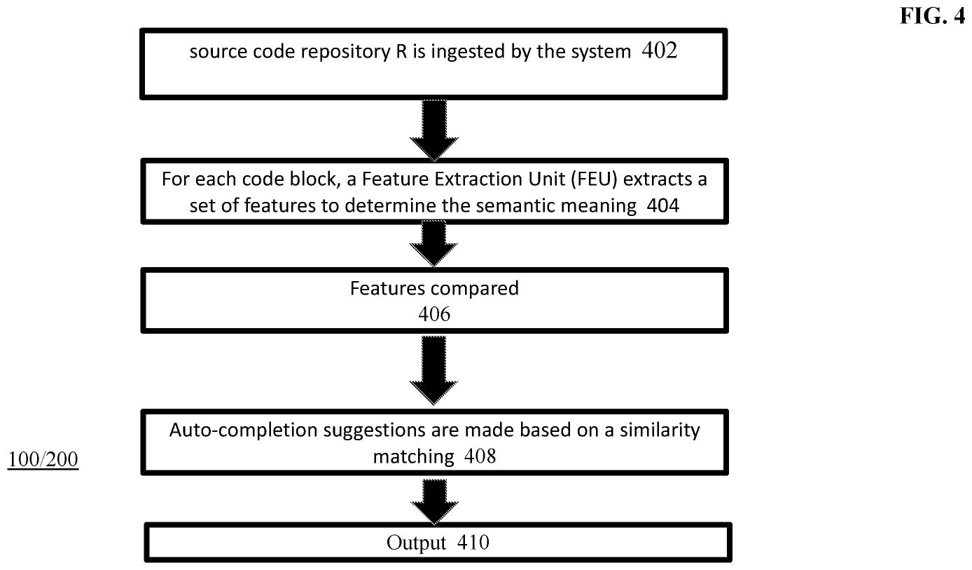

FIG. 4 illustrates a method of an example embodiment for code auto-suggestion based on structural and semantic features.

First, in a first step 402 a large source code repository R 112, 204 is ingested by the system 100, 200. For each source file in repository R 112, 204, code blocks are extracted at every lexical scope (e.g. functions, conditional statements, loops, etc.).

The features F_R can include features from source code based on its lexical structure (e.g. abstract syntax tree) and features from source code based on semantic clues (e.g. comments, static strings, variable and method names). An abstract syntax tree (AST), or syntax tree, is a tree representation of the abstract syntactic structure of source code written in a programming language, where each node of the tree denotes a construct occurring in the source code.

In the next step 404, for each code block, a Feature Extraction Unit (FEU) 302 extracts a set of features to determine the semantic meaning (e.g. preceding comments, variable names, contents of static string variables) and structure (e.g. abstract syntax tree). The FEU is extracting the more complex semantic features of code rather than syntactic features.

The FEU 302 can alternatively extract only certain aspects of the set of features to determine the sematic meaning. For example, the FEU 302 extracts the features of preceding comments and variable names for the semantic meaning and the loops of code for the structure.

In the next step 406, in the code editor 304, when a programmer 130 invokes a command to perform code auto-completion, the contents of the in-scope code (e.g. current line, current lexical scope, and/or current function) are passed to the FEU 302 to extract a set of features (or receive the set of features previously extracted from step 404) F_ac.

The features F_ac can include features from source code based on its lexical structure (e.g. abstract syntax tree) and features from source code based on semantic clues (e.g. comments, static strings, variable and method names).

These features F_ac are then compared (for example by a processor 104 or comparator 306) in step 406 with the set of features F_R extracted from repository R 112, 204 in step 404.

In step 408, auto-completion suggestions are made based on a similarity matching between the extracted set of features F_ac and features F_R in the repository R 112, 204.

Then the auto-complete suggestions are outputted 410 for completion of the source code. Please note that any of the steps can be performed in different sequences or combined or performed in parallel.

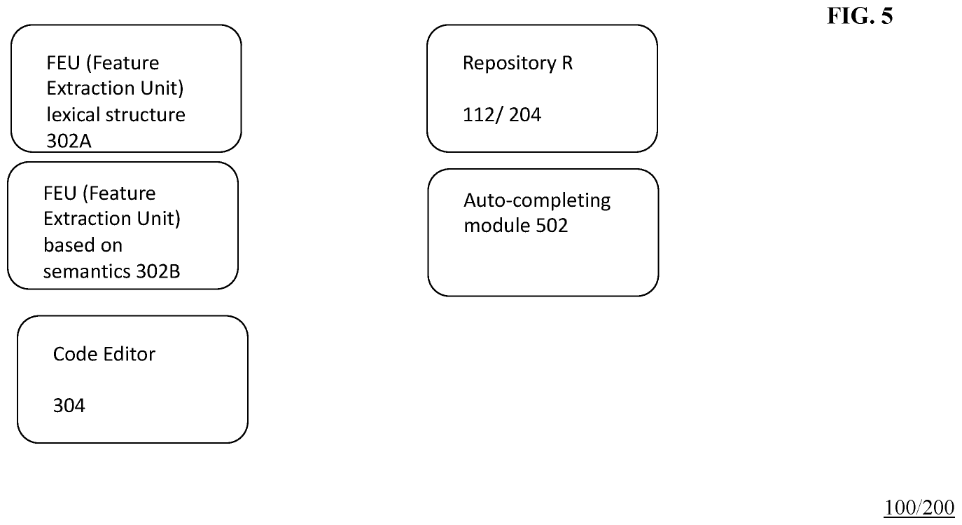

FIG. 5 illustrates further detail of the system in an example embodiment.

The system 100, 200 can include a repository 112, 204 of the source code, a code editor 304, a means for extracting features, from source code based on its lexical structure (e.g. abstract syntax tree) such as a feature extraction unit FEU for lexical structure 302A. The system 100/200 also includes a means for extracting features from /source code based on semantic clues (e.g. comments, static strings, variable and method names), such as the FEU (Feature Extraction Unit) based on semantics 302B. The FEU 302A and 304B can be separate modules or the same module as seen in FIG. 3.

The system 100, 200 can also include a means for auto-completing a block of code by extracting its features and performing a similarity matching with previously-extracted features from the source code repository, such as an autocompleting module 502.

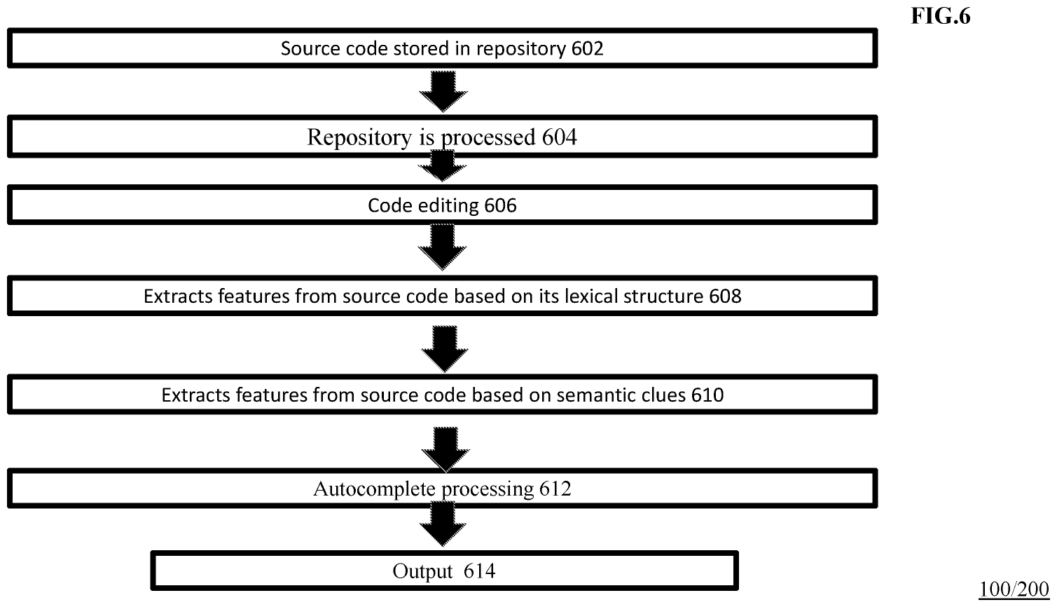

FIG. 6 illustrates a method for the system in an example embodiment.

First in step 602, the source code is stored in a for a repository of source code 112, 204. Then, the source code in the repository 112, 204 is processed 604, where a large source code repository R 112, 204 is ingested by the system 100, 200. For each source file in repository R 112, 204, code blocks are extracted at every lexical scope (e.g. functions, conditional statements, loops, etc.).

A code editor 304 is also included in the system 100, 200 in the code editor 304, when a programmer 130 invokes a command to perform code auto-completion, the contents of the in-scope code (e.g. current line, current lexical scope, and/or current function) are passed to the FEU 302A and 302B to extract a set of features in step 606.

Then in step 608, the FEU 302A extracts features from source code based on its lexical structure (e.g. abstract syntax tree). Then in step 610, FEU 302A extracts features from source code based on semantic clues (e.g. comments, static strings, variable and method names). Steps 608 and 610 can also be performed in parallel.

Then, in step 612 an autocomplete processing is performed by the autocomplete module 502, where auto-completing a block of code by extracting its features and performing a similarity matching with previously-extracted features from the source code repository is performed. The autocomplete data is then outputted 614 from the system 100, 200 for further processed for completion of the source code.

Moreover, please note that any of the steps can be performed in different sequences or combined or at the same time.

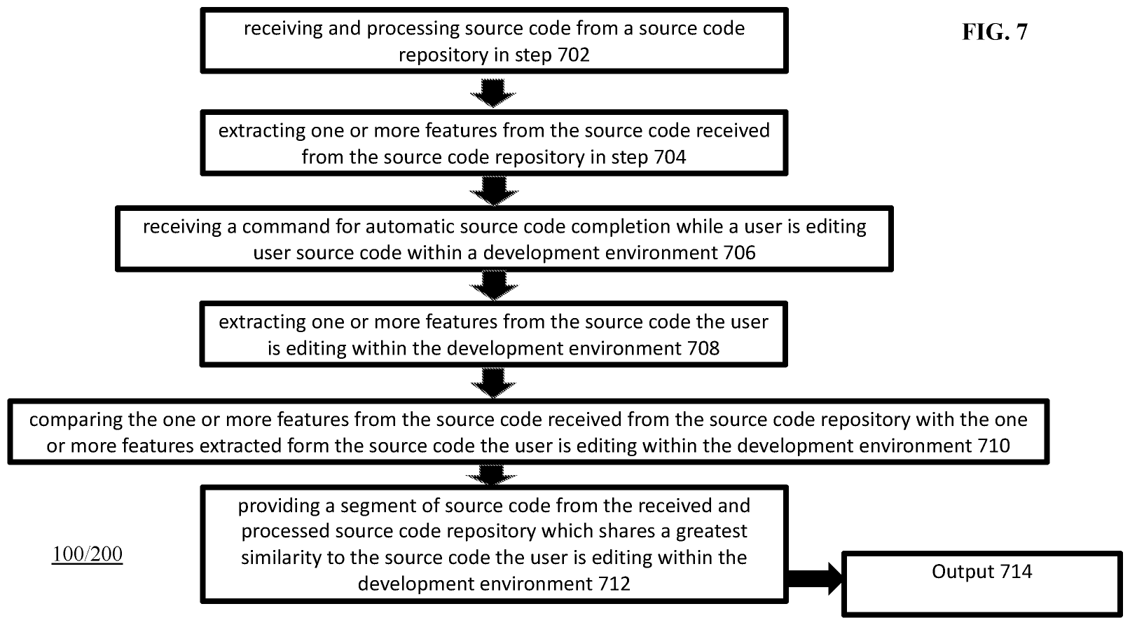

FIG. 7 illustrates a method of an example embodiment for code auto-suggestion based on structural and semantic features.

Referring FIG. 7, the system 100, 200 and method of automatically suggesting portions of source code for utilization within a development environment, includes the following.

First, there is a receiving and processing source code from a source code repository in step 702 by the system 100, 200. Then, there is extracting one or more features from the source code received from the source code repository in step 704. Then, there is a receiving a command for automatic source code completion while a user is editing user source code within a development environment 706. Then there is the extracting of one or more features from the source code the user is editing within the development environment 708. The semantic extraction can be made from anywhere in the source code in the development environment 706 or even from information in the comments for the source code.

Thereafter, there is the comparing the one or more features from the source code received from the source code repository with the one or more features extracted from the source code the user is editing within the development environment in step 710 by the system 100, 200.

Then there is a providing a segment of source code from the received and processed source code repository which shares a greatest similarity to the source code the user is editing within the development environment 712.

The features extracted from the source code include selectively one or more of comments, variable names, method names, contents of variables, and line numbers. Moreover, comparing the one or more features from the source code received from the source code repository occurs via machine learning or similarity-matching algorithms.

The data received from step 712 is then outputted in step 714 by the system 100, 200. The outputted information can be displayed on a display device for a user.

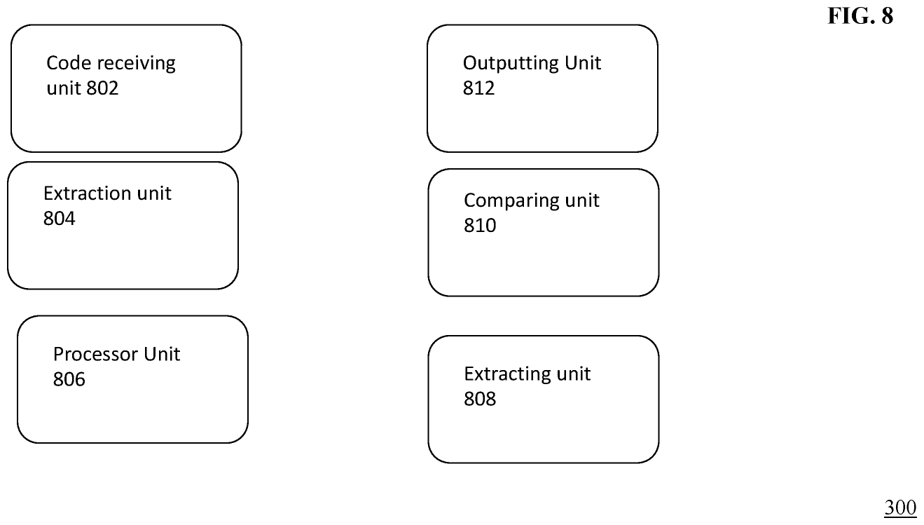

FIG. 8 illustrates a system 300 of an example embodiment for code auto-suggestion based on structural and semantic features.

First, there is a receiving and processing source code from a source code repository in a code receiving unit 802. Then, there is extracting one or more features from the source code received from the source code repository in an extracting unit 804. Then, there is a receiving a command for automatic source code completion while a user is editing user source code within a development environment in processing unit 806. Then there are the extracting one or more features from the source code the user is editing within the development environment in extracting unit 808.

Thereafter, there is comparing the one or more features from the source code received from the source code repository with the one or more features extracted from the source code the user is editing within the development environment in a comparing unit 810.

Then there is a providing a segment of source code from the received and processed source code repository which shares a greatest similarity to the source code the user is editing within the development environment by the processing unit 806 and outputting unit 812.

Referring back to FIGS. 1 and 2, as referring to FIG. 7, first, there is a receiving and processing source code from a source code repository 112 or Cloud storage implementation 204. Then, there is extracting one or more features from the source code received from the source code repository by the client computer 102, the client app 202 or even the server 110. Then, there is a receiving a command for automatic source code completion while a user 130 is editing user source code within a development environment in the client app 202 or client computer 102. Then there are the extracting one or more features from the source code the user is editing within the development environment by the client app 202 or the processor 104 in the client computer 102. The client computer 102 also includes the program 106 stored in memory 108. Device A 114 and device B 116 with memories 118 and 120, respectively, can provide the data to be stored in the repository 112 and 204.

Thereafter, there is comparing the one or more features from the source code received from the source code repository with the one or more features extracted from the source code the user is editing within the development environment by the client app 202 or processor 104 in client computer 102.

Then there is a providing a segment of source code from the received and processed source code repository which shares a greatest similarity to the source code the user is editing within the development environment by the client app 202 or client computer 102.

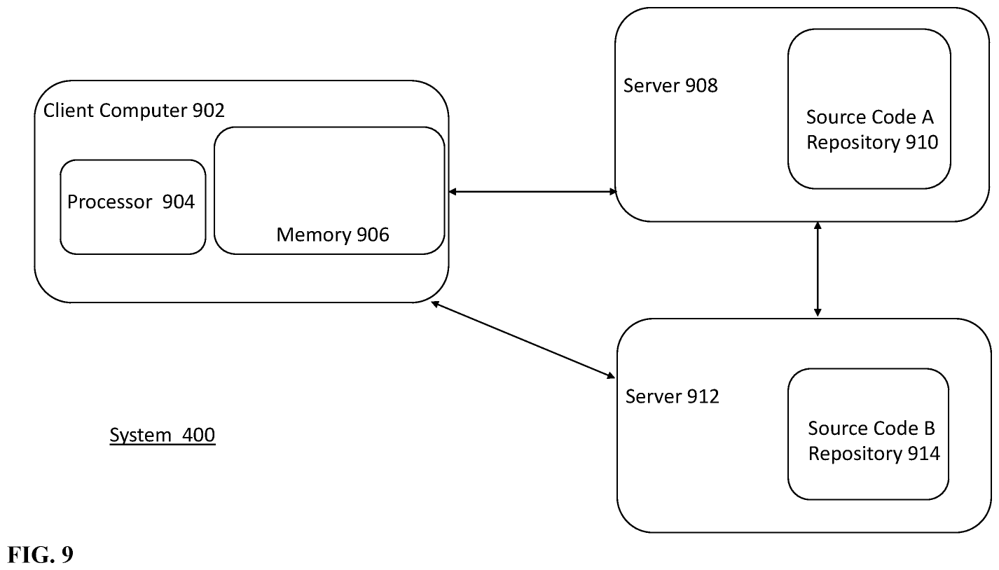

FIG. 9 illustrates an example implementation for code auto-suggestion based on structural and semantic features in system 400. In this example, the repository for the source code can be divided into a plurality of servers such as servers 908 and 912. Therefore, the client computer 902 with processor 904 and program in memory 906 can extract features from the repository A 910 and/or repository B 914.

Therefore, the systems 100, 200, 300, and 400 provide auto-completed code block suggestions based on code and comments being written in a code editor. Code block suggestions are drawn from a large repository of previously written source code or dynamically written in real time. Machine learning and similarity-matching algorithms are used to determine which code blocks are used to perform an auto-completion.

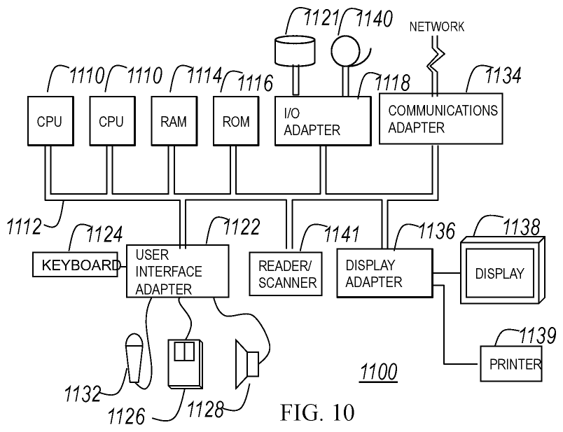

FIG. 10 illustrates another hardware configuration of the system 100, where there is an information handling/computer system 1100 in accordance with the present invention and which preferably has at least one processor or central processing unit (CPU) 1110 that can implement the techniques of the invention in a form of a software program for source code auto-suggestion based on structural and semantic features.

The CPUs 1110 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1126, speaker 1128, microphone 1132, and/or other user interface device to the bus 1112), a communication adapter 1134 for connecting an information handling system to a data processing network, the Internet, an Intranet, a personal area network (PAN), etc., and a display adapter 1136 for connecting the bus 1112 to a display device 1138 and/or printer 1139 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing storage media tangibly embodying a program of machine-readable instructions executable by a digital data processor incorporating the CPU 1110 and hardware above, to perform the method of the invention.

This signal-bearing storage media may include, for example, a RAM contained within the CPU 1110, as represented by the fast-access storage for example.

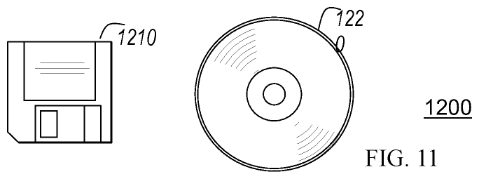

Alternatively, the instructions may be contained in another signal-bearing storage media 1200, such as a magnetic data storage diskette 1210 or optical storage diskette 1220 (FIG. 11), directly or indirectly accessible by the CPU 1210.

Whether contained in the diskette 1210, the optical disk 1220, the computer/CPU 1210, or elsewhere, the instructions may be stored on a variety of machine-readable data storage media.

Therefore, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention.

In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

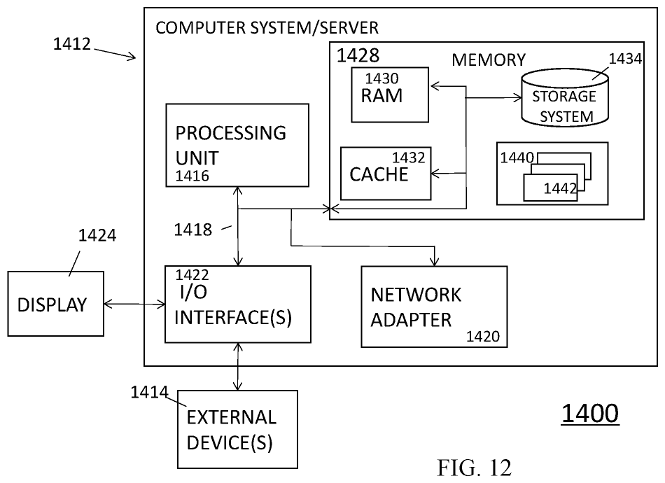

Referring now to FIG. 12, a schematic 1400 of an example of a cloud computing node is shown. Cloud computing node 1400 is only one example of a suitable cloud computing node and is not intended to suggest any limitation as to the scope of use or functionality of embodiments of the invention described herein. Regardless, cloud computing node 1400 is capable of being implemented and/or performing any of the functionality set forth hereinabove.

In cloud computing node 1400 there is a computer system/server 1412, which is operational with numerous other general purpose or special purpose computing system environments or configurations. Examples of well-known computing systems, environments, and/or configurations that may be suitable for use with computer system/server 1412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1412 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1412 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, computer system/server 1412 in cloud computing node 1400 is shown in the form of a general-purpose computing device. The components of computer system/server 1412 may include, but are not limited to, one or more processors or processing units 1416, a system memory 1428, and a bus 1418 that couples various system components including system memory 1428 to processor 1416.

Bus 1418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1412 typically includes a variety of computer system readable media. Such media may be any available media that is accessible by computer system/server 1412, and it includes both volatile and non-volatile media, removable and non-removable media.

System memory 1428 can include computer system readable media in the form of volatile memory, such as random-access memory (RAM) 1430 and/or cache memory 1432. Computer system/server 1412 may further include other removable/non-removable, volatile/non-volatile computer system storage media. By way of example only, storage system 1434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1418 by one or more data media interfaces. As will be further depicted and described below, memory 1428 may include at least one program product having a set (e.g., at least one) of program modules that are configured to carry out the functions of embodiments of the invention.

Program/utility 1440, having a set (at least one) of program modules 1442, may be stored in memory 1428 by way of example, and not limitation, as well as an operating system, one or more application programs, other program modules, and program data. Each of the operating system, one or more application programs, other program modules, and program data or some combination thereof, may include an implementation of a networking environment. Program modules 1442 generally carry out the functions and/or methodologies of embodiments of the invention as described herein.

Computer system/server 1412 may also communicate with one or more external devices 1414 such as a keyboard, a pointing device, a display 1424, etc.; one or more devices that enable a user to interact with computer system/server 1412; and/or any devices (e.g., network card, modem, etc.) that enable computer system/server 1412 to communicate with one or more other computing devices. Such communication can occur via Input/Output (I/O) interfaces 1422. Still yet, computer system/server 1412 can communicate with one or more networks such as a local area network (LAN), a general wide area network (WAN), and/or a public network (e.g., the Internet) via network adapter 1420. As depicted, network adapter 1420 communicates with the other components of computer system/server 1412 via bus 1418. It should be understood that although not shown, other hardware and/or software components could be used in conjunction with computer system/server 1412. Examples, include, but are not limited to: microcode, device drivers, redundant processing units, external disk drive arrays, RAID systems, tape drives, and data archival storage systems, etc.

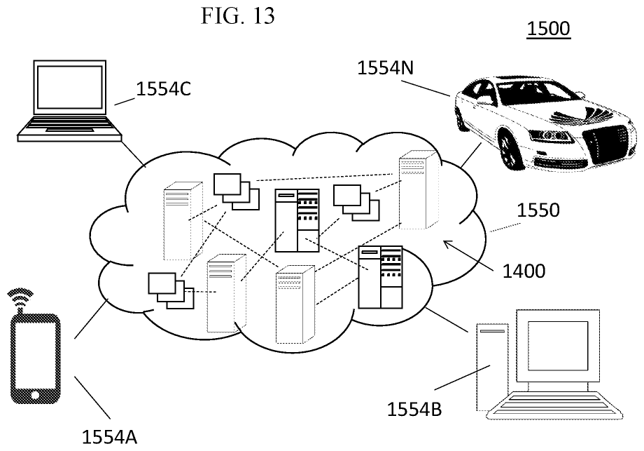

Referring now to FIG. 13, illustrative cloud computing environment 1550 is depicted. As shown, cloud computing environment 1550 includes one or more cloud computing nodes 1400 with which local computing devices used by cloud consumers, such as, for example, personal digital assistant (PDA) or cellular telephone 1554A, desktop computer 1554B, laptop computer 1554C, and/or automobile computer system 1554N may communicate. Nodes 1400 may communicate with one another. They may be grouped (not shown) physically or virtually, in one or more networks, such as Private, Community, Public, or Hybrid clouds as described hereinabove, or a combination thereof. This allows cloud computing environment 1550 to offer infrastructure, platforms and/or software as services for which a cloud consumer does not need to maintain resources on a local computing device. It is understood that the types of computing devices 1554A-N shown in FIG. 13 are intended to be illustrative only and that computing nodes 1400 and cloud computing environment 1550 can communicate with any type of computerized device over any type of network and/or network addressable connection (e.g., using a web browser).

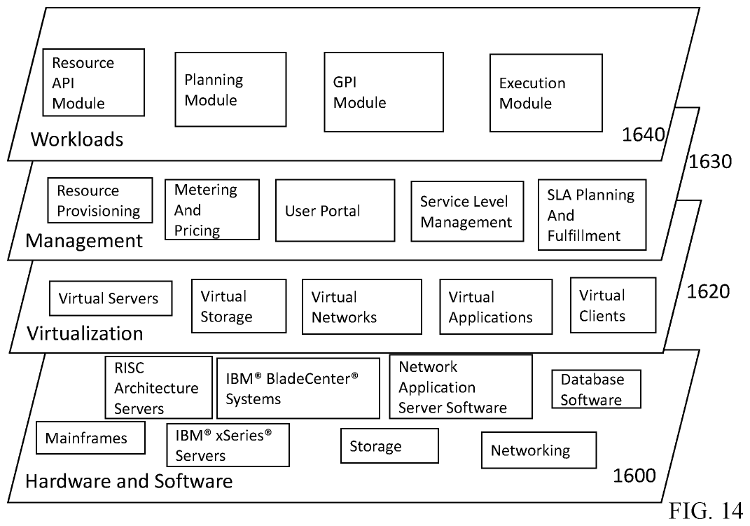

Referring now to FIG. 14, a set of functional abstraction layers provided by cloud computing environment 1550 (FIG. 13) is shown. It should be understood in advance that the components, layers, and functions shown in FIG. 14 are intended to be illustrative only and embodiments of the invention are not limited thereto. As depicted, the following layers and corresponding functions are provided:

Hardware and software layer 1660 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, Web Sphere, and DB2 are trademarks of International Business Machines Corporation registered in many jurisdictions worldwide).

Virtualization layer 1662 provides an abstraction layer from which the following examples of virtual entities may be provided: virtual servers; virtual storage; virtual networks, including virtual private networks; virtual applications and operating systems; and virtual clients.

In one example, management layer 1664 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1666 provides examples of functionality for which the cloud computing environment may be utilized. Examples of workloads and functions which may be provided from this layer include such functions as mapping and navigation; software development and lifecycle management; virtual classroom education delivery; data analytics processing; transaction processing; and, more particularly relative to the present invention, the APIs and run-time system components of generating search autocomplete suggestions based on contextual input.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

What is claimed is:

1. A method for source code auto-suggestion, the method comprising:
receiving and processing source code from a source code repository;
extracting one or more features from the source code received from the source code repository;
extracting one or more features from the source code within a development environment;
comparing the one or more features from the source code received from the source code repository with the one or more features extracted from the source code within the development environment; and
providing a segment of source code from the received and processed source code repository according to a similarity to the source code within the development environment.

2. The method according to claim 1, further comprising:
receiving a command for automatic source code completion while a user is editing user source code within the development environment; and
receiving the one or more features extracted from the source code within the development environment after receiving the command for automatic source code completion.

3. The method according to claim 1, wherein the one or more features extracted from the source code within the development environment is initiated when the user is editing within the development environment.

4. The method according to claim 1, wherein the segment of source code is provided according to a selection of the processed source code from the repository that shares a greatest similarity to the source code within the development environment.

5. The method of claim 1, wherein the features extracted from the source code include a selection of one or more from a group including comments, variable names, method names, contents of variables, and line numbers.

6. The method of claim 1, wherein the comparing occurs via machine learning or similarity-matching algorithms.

7. The method according to claim 1, further comprising automatically suggesting portions of source code for utilization within the development environment.

8. The method according to claim 1 being cloud implemented.

9. A system for source code auto-suggestion, comprising:
a computer, comprising:
a memory storing computer instructions; and
a processor configured to execute the computer instructions to:
receive and processing source code from a source code repository;
extract one or more features from the source code received from the source code repository;
extract one or more features from the source code within a development environment;
compare the one or more features from the source code received from the source code repository with the one or more features extracted from the source code within the development environment; and
provide a segment of source code from the received and processed source code repository according to a similarity to the source code within the development environment.

10. The system according to claim 9, further comprising:
receiving a command for automatic source code completion while a user is editing user source code within the development environment; and
receiving the one or more features extracted from the source code within the development environment after receiving the command for automatic source code completion.

11. The system according to claim 9, wherein the one or more features extracted from the source code within the development environment is initiated when the user is editing within the development environment.

12. The system according to claim 9, wherein the segment of source code is provided according to a selection of the processed source code from the repository that shares a greatest similarity to the source code within the development environment.

13. The system according to claim 9, wherein the features extracted from the source code include a selection of one or more from a group including comments, variable names, method names, contents of variables, and line numbers.

14. The system according to claim 9, wherein comparing occurs via machine learning or similarity-matching algorithms.

15. The system according to claim 9, further comprising of automatically suggesting portions of source code for utilization within the development environment that is cloud implemented.

16. A computer program product comprising a computer readable storage medium having program instructions embodied therewith, the program instructions readable and executable by a computer to cause the computer to perform a method, comprising:
receiving and processing source code from a source code repository;
extracting one or more features from the source code received from the source code repository;
extracting one or more features from the source code within a development environment;
comparing the one or more features from the source code received from the source code repository with the one or more features extracted from the source code within the development environment; and
providing a segment of source code from the received and processed source code repository according to a similarity to the source code within the development environment.

17. The computer program product according to claim 16, further comprising:
receiving a command for automatic source code completion while a user is editing user source code within the development environment; and
receiving the one or more features extracted from the source code within the development environment after receiving the command for automatic source code completion.

18. The computer program product according to claim 16, wherein the one or more features extracted from the source code within the development environment is initiated when the user is editing within the development environment.

19. The computer program product according to claim 16, wherein the segment of source code is provided according to a selection of the processed source code from the repository that shares a greatest similarity to the source code within the development environment, and
wherein the features extracted from the source code include a selection of one or more from a group including comments, variable names, method names, contents of variables, and line numbers.

20. The computer program product according to claim 16, wherein comparing the one or more features from the source code received from the source code repository occurs via machine learning or similarity-matching algorithms,
wherein portions of the source code are automatically suggested for utilization within the development environment, and
the computer program product being cloud implemented.
